(19) United States
(12) Patent Application Publication
(10) Pub. No.: US 2012/0081420 A1
(43) Pub. Date: Apr. 5, 2012

(54) PRINTING SYSTEM

(76) Inventors: Rong Ho YU, Hsin-Chu (TW); Wen Hsiung Liao, Hsin-Chu (TW); Hsien Chung Tai, Hsin-Chu (TW); Cheng Ming Chang, Hsin-Chu (TW)

(21) Appl. No.: 13/226,905

(22) Filed: Sep. 7, 2011

(30) Foreign Application Priority Data
Sep. 30, 2010 (CN) 201010503670.7

(51) Int. Cl. B41J 2/01

(52) U.S. Cl. 347/1

(57) ABSTRACT

The present invention relates to a printing system, which comprises: a data receiving and processing unit connected with the electronic device, for receiving a printing signal from the electronic device and processing the printing signal into a data signal; and an ink-jet head module including a control chip and an ink-jet heating chip. The control chip includes a wireless transmission module and a control circuit, wherein the wireless transmission module includes an antenna, a front-end processing unit, an instruction unit, a clock transmission unit, and a modulation and demodulation unit. Besides, the control circuit includes a control processing unit, a coding and decoding processing unit, and a memory device, to receive the data signal processed by the wireless transmission module and transform the processed data signal into a control signal. In addition, the ink-jet heating chip is connected with the control circuit for executing the ink-jet printing.

This application claims the benefits of the China Patent Application Serial Number 201010503670.7, filed on Sep. 30, 2010, the subject matter of which is incorporated herein by reference.

### BACKGROUND OF THE INVENTION

1. Field of the Invention

The present invention relates to a printing system, more particularly, to the printing system capable of transmitting the data signal wirelessly, to the control chip of the ink-jet head module thereof.

2. Description of Related Art

The present ink-jet printing technology becomes more and more complicated. Each kinds of ink-jet head module has its own specific specification, and could include different kinds of ink, different number of nozzles, different kinds of ink-jet control circuit and different kinds of identification circuit. Therefore, a compatible printing system must be applied with a specific kind of ink-jet head module, for correctly executing the ink jet printing process. For this reason, a control circuit is required for controlling the operation of the specific kind of ink-jet head module. Thus, the control circuit becomes the criterion in determining whether the specific kind of ink jet head module is operable in the printing system.

Please refer to FIG. 1, which is a perspective view of a conventional printing system. As shown in the figure, the conventional printing system 11 is connected with a computer 10, and consisted of a data receiving and processing unit 111 and an ink-jet head module 112. The data receiving and processing unit 111 is electrically connected with the metal contact of the ink-jet head module 112, through plural of wires. The ink-jet head module 112 further includes plural of ink-jet heating elements (not shown in the figure) at the interior thereof When the data receiving and processing unit 111, at the interior of the printing system 11, receives the printing signal transmitted from the computer 10, the data receiving and processing unit 111 transmits the printing signal to the ink-jet head module 112, in order to drive the control circuit 11211 of the ink-jet chip 1121. Then, the control circuit 11211 controls the ink-jet circuit 11212 to execute the ink-jet printing process.

However, since the control circuit 11211 and the ink-jet circuit 11212 are fabricated on the same ink-jet chip 1121, the operation of the control circuit 11211 is affected by the heat generated by the ink-jet heating elements at the interior of the ink-jet circuit 11212. Besides, during the execution of the ink-jet printing process, the control circuit 11211 is eroded by the ink. That is, the disorder and the interference are happened in the control circuit 11211 during the execution of the ink-jet printing process, resulting in the errors in the ink-jet printing process.

Furthermore, since the ink-jet head module 112 is electrically connected with the data receiving and processing unit 111 through the metal contact thereof, the manufacturing cost of the ink-jet head module 112 is increased. In addition, the metal contact is easily damaged by the extreme heat generated by the ink-jet heating element, resulting in the error of the printing signal and the bad printing result.

Therefore, a printing system, capable of obviating the drawbacks mentioned above, is required by the industry.

### SUMMARY OF THE INVENTION

The main object of the present invention is to provide a printing system, capable of obviating the drawbacks including: both of the high manufacturing cost and the easily damage, caused by the extreme heat generated by the ink-jet heating element, of the metal contact of the ink-jet head module of the conventional printing system, and the disorder and the interference happened in the control circuit, caused by the extreme heat and the erosion of the ink, resulting in the error in the ink-jet printing process, caused by the installation of the control circuit and the ink-jet circuit on the same ink-jet chip.

To achieve the object, in a broader type of the present invention, a printing system is provided, connected with an electronic device, at least comprising: a data receiving and processing unit connected with the electronic device, for receiving a printing signal from the electronic device and processing the printing signal into a data signal; an ink-jet head module at least including: a control chip including a wireless transmission module and a control circuit, wherein the wireless transmission module includes an antenna, a front-end processing unit, an instruction unit, a clock transmission unit, and a modulation and demodulation unit, at the interior thereof, in order to communicate with the data receiving and processing unit wirelessly for receiving the data signal; the control circuit includes a control processing unit, a coding and decoding processing unit, and a memory device, in order to receive the data signal having been processed by the wireless transmission module and transform the processed data signal into a control signal; and an ink-jet heating chip connected with the control circuit, for executing the ink-jet printing process in response to the driving of the control signal.

### BRIEF DESCRIPTION OF THE DRAWINGS

FIG. 1 is a perspective view of a conventional printing system.

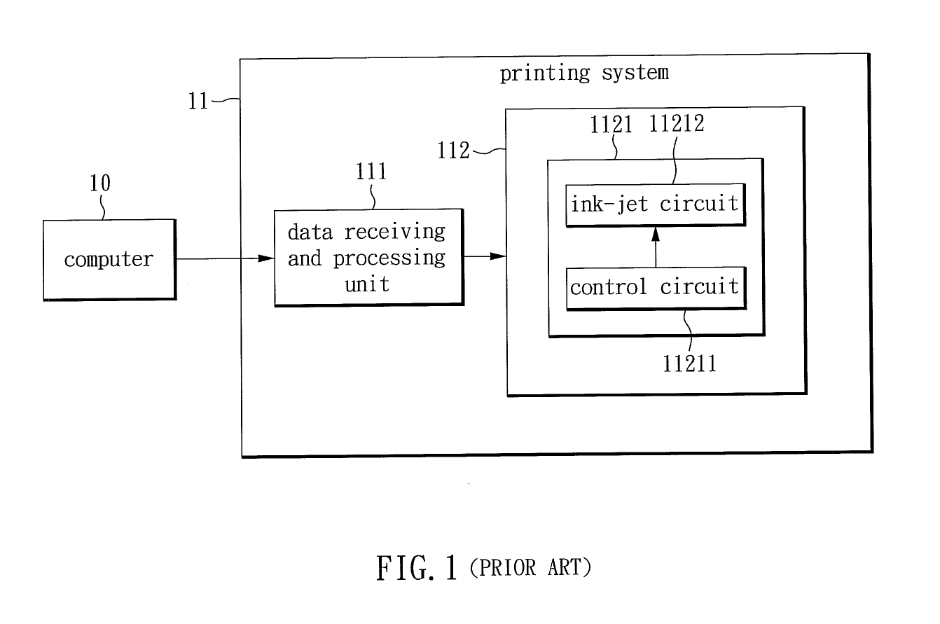

FIG. 2 is a perspective view displaying the structure of the printing system according to one preferred embodiment of the present invention.

FIG. 3 is a perspective view displaying the internal circuit structure of the control chip shown in FIG. 2.

FIG. 4 is a perspective view displaying the circuit structure of the heating element including at the interior of the ink-jet heating chip shown in FIG. 2.

### DETAILED DESCRIPTION OF THE PREFERRED EMBODIMENT

Other objects, advantages, and novel features of the invention will become more apparent from the following detailed description when taken in conjunction with the accompanying drawings. The description and the drawing in the specification of the present invention are essentially used for explanation only; they are not supposed to be used for limiting the scope of the present invention.

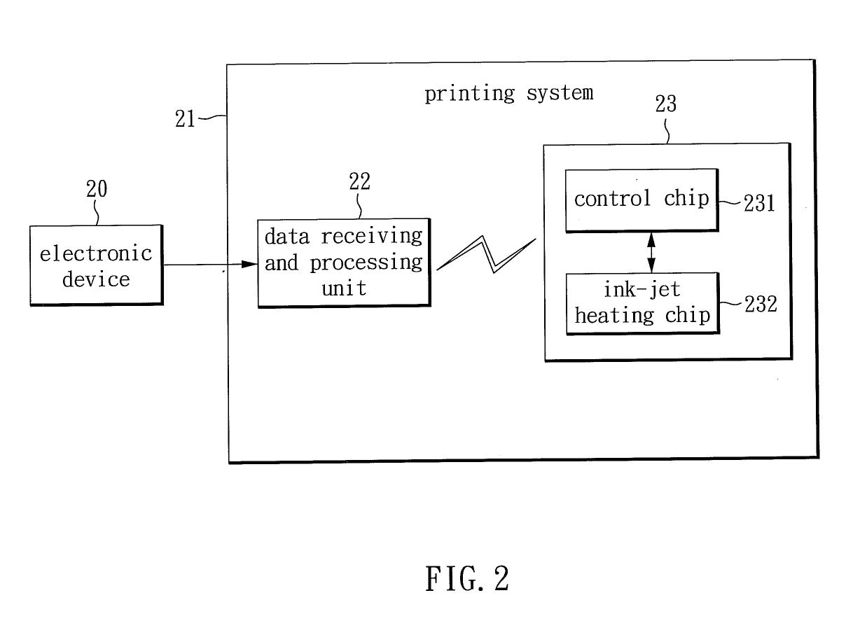

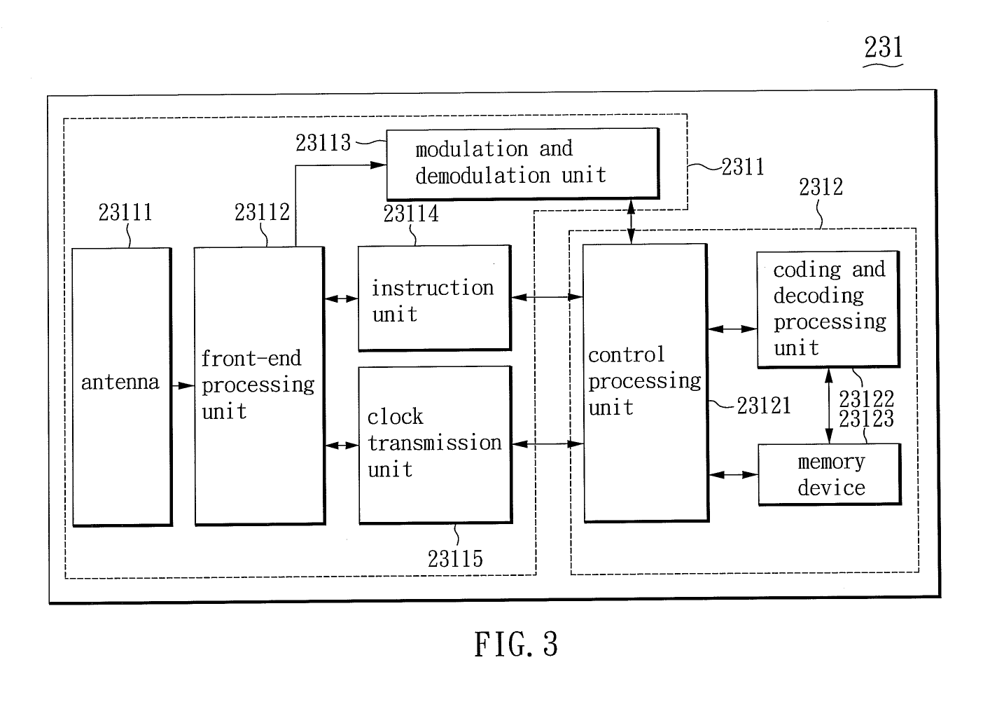

Please refer to FIG. 2 and FIG. 3, wherein FIG. 2 is a perspective view displaying the structure of the printing system according to one preferred embodiment of the present invention, and FIG. 3 is a perspective view displaying the internal circuit structure of the control chip shown in FIG. 2. As shown in the figures, the printing system 21 of the present invention is connected with an electronic device 20, wherein the electronic device 20 could be an electronic apparatus including a computer or a mobile phone, etc. The printing system 21 could comprises a data receiving and processing unit 22 and an ink-jet head module 23, wherein the data receiving and processing unit 22 is connected with the electronic device 20, for receiving a printing signal transmitted from the electronic device 20 and processing the printing signal into a data signal. The ink-jet head module 23 could include a control chip 231 and an ink-jet heating chip 232 at the interior thereof. The data receiving and processing unit 22 of the present invention could be installed on the body of a printer, while the ink-jet head module 23 could be installed on a printing cartridge.

The benefit of the inclusion of the control chip 231 and an ink-jet heating chip 232, at the interior of the ink-jet head module 23 of the present invention, will be described hereinafter:

The control chip 231 is used as the control circuit at the interior of the ink-jet head module 23, while the ink-jet heating chip 232 is used as the ink-jet circuit at the interior of the ink jet head module 23. The control means is as follows: The electronic device 20 (such as a computer) provides a printing signal to the printing system 21 (such as a printer). The printing system 21 receives the printing signal and transmits the processed printing signal to the ink-jet head module 23. The signal is further processed by the control chip 231 and then transmitted to the ink-jet heating chip 232. The ink jet heating chip 232 executes an ink-jet printing process, in response to the processed signal. Thus, an ink-jet printing process is completed.

The benefit of the above control means including:

(1) Since most of the control circuits are digital logic circuits, these control circuits can be fabricated as the control chip 231, while the ink-jet circuit is fabricated with the conventional technology. Thus, the space occupied by the digital logic circuits on the ink-jet heating chip 232 can be reduced significantly, resulting in the decrease of the manufacturing cost of the ink-jet heating chip 232. In addition, as the control circuit can be fabricated as the control chip 231 with the current advanced technology, the manufacturing cost thereof is also decreased.

(2) In the conventional printing system, the control circuit and the ink-jet circuit are fabricated on the same ink-jet chip. As being affected by the extreme heat, disorder and interference are happened in the digital logic circuit, resulting in the error in the ink-jet printing process. However, in the present invention, the control circuit and the ink-jet circuit could be fabricated on different chips. Thus, the aforementioned drawback can be obviated.

(3) Since the control circuit is fabricated with the current advanced technology, plural sets of control circuits can be installed on one small control chip 231, for controlling plural of ink-jet heating chips 232 at the same time.

(4) Since the control circuit and the ink-jet circuit can be fabricated on different chips, the interference, due to the affection from the ink-jet element (such as the heat effect of the heating element, or the erosion of the ink), is hardly happened. Thus, the wireless transmission technology and the control circuit can be integrated on the same chip, i.e. the control chip 231. The wireless transmission technology is applied in the communication between the printer body and the control chip 231. As a result, the larger number of wires used for the connection between the printer body and the control chip 231 can now be eliminated, when larger number of ink-jet heating chips 232 is controlled for executing the ink-jet printing.

Please refer to FIG. 3 again, the control chip 231 of the present invention could include a wireless transmission module 2311 and a control circuit 2312. In the present embodiment, the wireless transmission module 2311 could include an antenna 23111, a front-end processing unit 23112, a modulation and demodulation unit 23113, an instruction unit 23114 and a clock transmission unit 23115. The wireless transmission module 2311 communicates with the data receiving and processing unit 22 wirelessly, for receiving the data signal and further processing the data signal, such as modulating and/or demodulating the data signal. The control circuit 2312 could include a control processing unit 23121, a coding and decoding processing unit 23122, and a memory device 23123. The control circuit 2312 receives the data signal, having been processed by the wireless transmission module 2311, and transforms the processed data signal into a control signal.

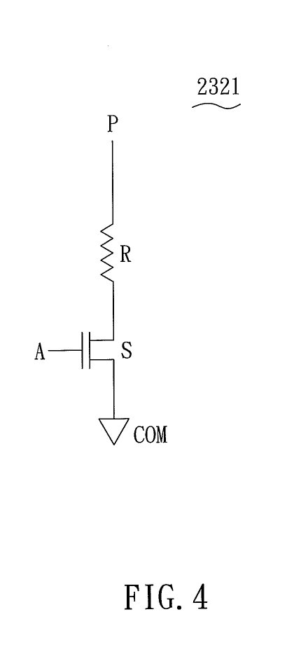

Please refer to FIG. 2, FIG. 3 and FIG. 4 at the same time, wherein FIG. 4 is a perspective view displaying the circuit structure of the heating element including at the interior of the ink-jet heating chip shown in FIG. 2. As shown in the figures, the ink-jet heating chip 232 of the present invention is connected with the control chip 231 through a wire. The ink-jet heating chips 232 includes plural of heating elements 2321, for executing the ink-jet printing process in response to the driving of the control signal transmitted from the control circuit 2312 of the control chip 231.

Please refer to FIG. 4 again, each of the plural heating elements 2321, included at the interior of the ink-jet heating chips 232, is consisted of a driving transistor S, a heating resistor R, an input end A (address), an input end P (power), and a common end COM. One end of the heating resistor R is connected with the drain end of the driving transistor S, while the other end of the heating resistor R is connected with the input end P. The common end COM and the input end A are respectively connected with the source end and the gate end of the driving transistor S. The common end COM is further connected with a ground end. When an ink-jet printing process is executed, an address signal is transmitted from the input end A, making the driving transistor S at the conduction state. At this time, a power signal is transmitted from the input end P. Thus, the temperature of the heating resistor R is increased, in order to heat the ink for producing bubbles, and then jetting ink onto a printing media as a result.

Please refer to FIG. 2 and FIG. 4, the control signal transmitted from the control circuit 2312 of the control chip 231 of the present invention, could include the address signal transmitted from the input end A, and the power signal transmitted from the input end P. However, the signal could include other kinds of signals, not necessarily limited to the address signal and the power signal. In some embodiments of the present invention, the control signal transmitted from the control circuit 2312, to the ink-jet heating chips 232, could only be an address signal. At this time, the power signal required by the input end P is transmitted through a wire.

As described above, at the interior of the printing system of the present invention, the control chip and the ink-jet heating chip are fabricated on two different chips. As a result, when the ink-jet heating chip heats the ink at the interior of the ink-jet head module, the normal operation of the control chip will not be interfered by the heat generated by the heating elements. Further, since the communication between the data receiving and processing unit and the ink-jet head module has been achieved through the wireless transmission, no metal contact is required on the ink-jet head module for the purpose of signal transmission anymore. Thus, the manufacturing cost of the ink-jet head module can be decreased, and the bad printing result, as a result of the interference happened in the signal transmission, caused by the heat generated by the heating element of the ink-jet heating chip, can also be avoided.

Although the present invention has been explained in relation to its preferred embodiment, it is to be understood that many other possible modifications and variations can be made without departing from the spirit and scope of the invention as hereinafter claimed.

What is claimed is:

1. A printing system, connected with an electronic device, at least comprising:
a data receiving and processing unit connected with the electronic device, for receiving a printing signal from the electronic device and processing the printing signal into a data signal;
an ink jet head module at least including:
a control chip including a wireless transmission module and a control circuit, wherein the wireless transmission module includes an antenna, a front-end processing unit, an instruction unit, a clock transmission unit, and a modulation and demodulation unit, at the interior thereof, in order to communicate with the data receiving and processing unit wirelessly for receiving the data signal; the control circuit includes a control processing unit, a coding and decoding processing unit, and a memory device, in order to receive the data signal having been processed by the wireless transmission module and transform the processed data signal into a control signal; and
an ink-jet heating chip connected with the control circuit, for executing the ink-jet printing process in response to the driving of the control signal.

2. The printing system as claimed in claim 1, wherein the electronic device is an electronic apparatus including a computer or a mobile phone, etc.

3. The printing system as claimed in claim 1, wherein the control chip is connected with the ink jet heating chip through a wire.

4. The printing system as claimed in claim 1, wherein the control signal includes an address signal and a power signal.

5. The printing system as claimed in claim 1, wherein the control signal is an address signal.

6. The printing system as claimed in claim 1, wherein the ink-jet heating chip includes a plurality of heating elements at the interior thereof.
